(19) United States
(12) Patent Application Publication
(10) Pub. No.: US 2006/0080180 A1
(43) Pub. Date: Apr. 13, 2006

(54) Method of verifying whether an on-line user is a member of an organization unrelated to a company

(76) Inventors: Paul Nathan Ens, Novato, CA (US); Anthony Francis Behen, Petaluma, CA (US)

Correspondence Address: LAW OFFICES OF MARK C. PICKERING, P.O. BOX 300, PETALUMA, CA, 94953, US

(21) Appl. No.: 10/961,788

(22) Filed: Oct. 7, 2004

(51) Int. Cl. G06Q 30/00

(52) U.S. Cl. 705/26

(57) ABSTRACT

An on-line company unrelated to an organization which has a domain name provides a service to an on-line user when the company confirms that the on-line user is a member of the organization. The organization establishes a sub-domain of the domain name of the organization, and then sets the IP address of the sub-domain to be equal to the IP address of the on-line company. The company then verifies membership by checking a cookie placed on the computer of the on-line user by the organization.

### BACKGROUND OF THE INVENTION

1. Field of the Invention

The present invention relates to a method of verification and, more particularly, to a method of verifying whether an on-line user is a member of an organization that is unrelated to a company.

2. Description of the Related Art

For a variety of reasons, companies commonly offer discounts to classes of people, such as the members of an organization. When a person purchases a product and seeks to obtain a discount, a company typically wants to obtain some kind of verification that the person seeking the discount is actually a person who is entitled to receive a discount, e.g., is actually a member of the organization.

When the discount is based on some relationship that the person has established with the company, such as being a member of a company-sponsored organization, the company can simply compare the personally identifying membership information provided by the person seeking the discount with the information the company has previously collected to verify whether the person seeking the discount is a registered member.

For example, an on-line company may wish to offer a discount to all of the on-line users who have registered with the company as a member of a company-sponsored organization, whether a free or fee-based membership. When an on-line user seeks to utilize the discount in a non-member area, the on-line company obtains personally identifying membership information, and then compares the membership information to the information the company has previously collected to verify whether the on-line user is a registered member.

Alternately, personally identifying membership information can be collected and verified during a log-in event, and stored as a cookie on the on-line user's computer. Cookies are designed to be read by only the domain name that created the cookie, and any sub-domain name of the domain name. The sub-domain names can represent, for example, different functions within the company.

For example, an on-line company can have the domain name company.com, and the sub-domain names shop.company.com and support.company.com. In this example, a cookie created by the domain name company.com includes personally identifying membership information that can be read by the sub-domain that handles the retail sales at shop.company.com, and by the sub-domain that handles customer questions at support.company.com.

As another example, a content provider, which has different content types, can have, for example, the domain name provider.com, and the sub-domain names news.provider.com and sports.provider.com. In this example, a cookie created by the domain name provider.com includes personally identifying membership information that can be read by the sub-domain that provides news content at news.provider.com (so that the content can be provided without requiring another log-in event), and by the sub-domain that provides sports content at sports.provider.com (so that the content can be provided without requiring another log-in event).

Returning from the examples, when it has been verified that the on-line user seeking the discount is a registered member, the on-line company applies the discount. However, when the on-line user seeking the discount is not a registered member, the discount is not applied. In this event, the on-line user seeking the discount can choose to register and receive the discount, or complete the transaction without the discount.

A much more difficult problem exists, however, when an on-line company seeks to offer a discount to the members of an organization that is unrelated to the on-line company. For example, when an on-line company that sells a branded product offers a discount to the members of an organization that is unrelated to the on-line company, but is otherwise associated with the brand, the on-line company has no previously collected information to use to verify whether an on-line user seeking the discount is entitled to receive a discount.

The well-known approach used by many brick-and-mortar operations where the company asks to see a membership card before granting the discount is typically not a viable option for an on-line company as the on-line company lacks the ability to “see” the membership card.

One approach for an on-line company is to ask the organization to provide the company with information about their members in exchange for the discount. For example, the organization can establish a way to share databases of user names and passwords with the on-line company to enable the discount program. However, many organizations and companies have privacy policies that prohibit the dissemination of membership information.

Further, even for organizations that share membership information with a company to obtain discounts for their members, the cost to the organization to continually provide current membership information can be significant. Similarly, the cost to the company receiving the membership information can also be significant in terms of processing and maintaining the membership information.

Thus, there is a need for a method that allows an on-line company to verify or authenticate that an on-line user seeking a discount based on being a member of an organization that is unrelated to the company is actually a person who is entitled to receive a discount.

### SUMMARY OF THE INVENTION

The present invention provides a method of determining whether an on-line user is a member of an organization before providing a service to the on-line user. The method includes the step of collecting information from an on-line user that indicates a service the on-line user has selected to receive from a company. The company has a server which has an IP address.

The method also includes the step of determining if the on-line user is a member of an organization after the on-line user has selected the service. The organization has a web site, a domain name, an IP address associated with the domain name, a sub-domain of the domain name, and an IP address associated with the sub-domain. The IP address associated with the sub-domain is the IP address of the server such that all packets addressed to the sub-domain are forwarded to the server. The method further includes the step of providing the service to the on-line user when the on-line user is a member of the organization.

The present invention includes another method of providing an on-line service. The method includes the steps of identifying an IP address of a server of an on-line company, and establishing a sub-domain name of a domain name of a web site of an organization. The method also includes the step of setting the IP address associated with the sub-domain name to be equal to the IP address of the server.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a flow chart illustrating an example of a method 100 of an organization supporting an on-line company in accordance with the present invention.

FIG. 2 is a flow chart illustrating an example of a method 200 of an on-line company providing a service in accordance with the present invention.

FIG. 3 is a flow chart illustrating an example of a method 300 of the on-line company determining if an on-line user is a member of an organization.

### DETAILED DESCRIPTION OF THE INVENTION

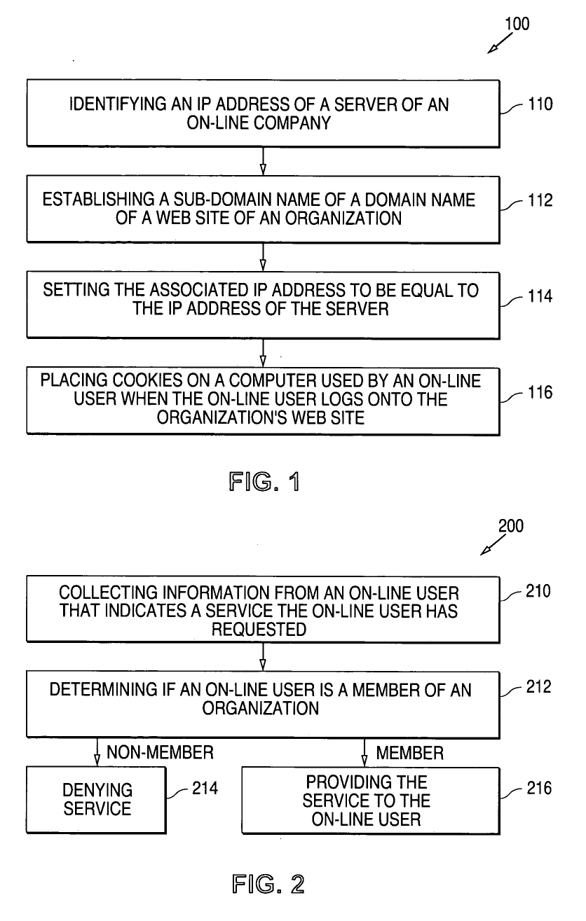

FIG. 1 shows a flow chart that illustrates an example of a method 100 of an organization supporting an on-line company in accordance with the present invention. FIG. 2 shows a flow chart that illustrates an example of a method 200 of an on-line company providing a service in accordance with the present invention.

Methods 100 and 200 assume that an organization and an on-line company have previously come to an agreement to work together to provide a service to the members of the organization. The service provided by the on-line company can be, for example, the provision of a discount, the provision of hosting services, or the provision of other services.

In the case of a discount, the organization desires to obtain, and the on-line company desires to provide, discounts for the members of the organization for the products sold by the on-line company. In the case of hosting services, the organization wishes that only members of the organization have access to the data files hosted by the on-line company. The data files can include documents, movies, music, or any other content.

As described in greater detail below, the organization supports the provision of services by the on-line company by creating a sub-domain name of the organization's domain name, forwarding all packets addressed to the sub-domain name to the on-line company, and placing cookies on the computers used by the members of the organization. The on-line company, which is unrelated to the organization, provides a service to an on-line user when the company confirms that the on-line user is a member of the organization using the cookies.

As shown in FIG. 1, method 100, which describes the steps taken by the organization, begins with step 110 by identifying an IP address of a server of the on-line company. In this example, the on-line company provides a service. Next, method 100 moves to step 112 to establish a sub-domain name of a domain name of a web site of the organization. The organization's domain name has an associated IP address, and the sub-domain name has an associated IP address. (Steps 110 and 112 can alternately be reversed.)

For example, assume that an organization, which wishes to obtain discounts for their members, has the domain name example.com. In step 112, method 100 establishes a sub-domain name of the domain name of the organization which could be, for example, shop.example.com.

Alternately, assume that an organization, which has the domain name example.com, wishes to provide movie trailers to their members. In step 112, method 100 establishes a sub-domain name of the domain name of the organization which could be, for example, trailers.example.com.

After this, method 100 moves to step 114 to set the IP address associated with the sub-domain name to be equal to the IP address of the server of the on-line company so that all packets addressed to the sub-domain name (e.g., shop.example.com or trailers.example.com) are forwarded to the IP address of the server of the on-line company.

Following steps 110-114, which are off-line, set-up steps, method 100 moves to step 116 where, when on line, cookies are placed on the computer used by an on-line user when the on-line user logs onto the organization's web site. The log-in event causes the organization's web site to generate and output a session-based cookie.

In addition to a session-based cookie, the organization's web site can also generate and output a persistent cookie when an on-line user becomes a member (and each subsequent time the on-line user logs on and no longer has the persistent cookie). The persistent cookie can include, for example, customization information for customizing the pages of the organization's web site.

In the present invention, the session-based cookie and the persistent cookie are not globally unique identifiers that can be read by multiple domain names, but are defined to be files or identifiers which can only be read by the domain name that created the cookie, and the sub-domains of the domain name.

In accordance with the present invention, the organization's web site inserts a membership tag or other identifier into the session-based and persistent cookies that identifies the on-line user as a member, but which does not provide any personally identifying information about the on-line user. The membership tag does not include any information regarding, for example, the member's user name, password, actual name, address, age, sex, or financial status. The membership tag only indicates that the on-line user is a member.

For example, the organization can generate a cookie which includes no personally identifying information by combining the membership tag (which includes no personally identifying information) with other non-personally identifying information. Alternately, the organization can encrypt any personally identifying information, such as credit card information, and then combine the membership tag (which includes no personally identifying information) and the encrypted information to form the cookie.

Turning now to FIG. 2, method 200, which describes the steps taken by the on-line company, begins with step 210 by collecting information from an on-line user that indicates a service the on-line user has requested to receive from a company. In the discount example, where the on-line company can generate one or more pages that offer merchandise for sale, the on-line company can detect the on-line user's request for a discount.

Alternately, the on-line company can detect the on-line user's completion of a transaction, and automatically generate an internal request for a discount. In the hosting example, where the on-line company can generate one or more pages of available data files, the on-line company can detect the on-line user's request for a particular data file.

Following this, method 200 moves to step 212 to determine if the on-line user is a member of an organization. When the on-line user is not a member of the organization, method 200 moves to step 214 to deny the service to the on-line user. When service is denied, the on-line user can be provided the opportunity to become a member (at the organization's web site) and receive the discount or download the file or, in the case of a purchase, complete the transaction without the discount.

On the other hand, when the on-line user is a member of the organization, method 200 moves to step 216 to provide the service to the on-line user. In the discount example, the on-line company applies a discount to the purchase price of the products selected by the on-line user. In the hosting example, the on-line company outputs the selected data files to the on-line user.

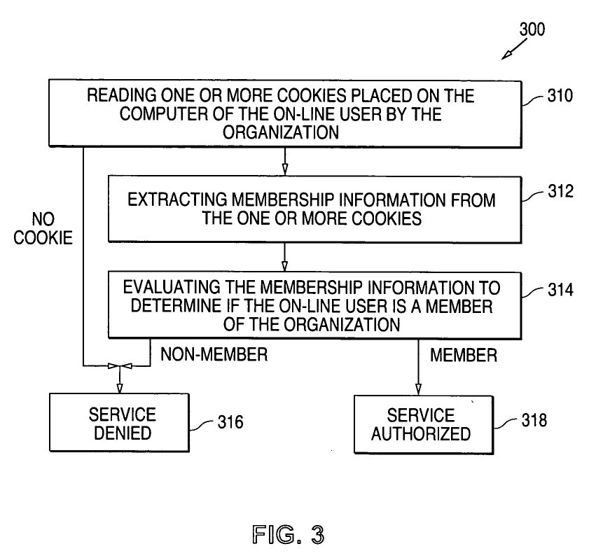

FIG. 3 shows a flow chart that illustrates an example of a method 300 of the on-line company determining if an on-line user is a member of an organization. As shown in FIG. 3, method 300 begins with step 310 by reading one or more cookies from the on-line user's computer. The one or more cookies read in step 310 were placed on the user's computer by the organization's web site.

In the present invention, the organization's web site places both a session-based cookie and a persistent cookie on the on-line user's computer, and the on-line company reads both the session-based cookie and the persistent cookie. Alternately, only the session-based cookie or the persistent cookie can be placed and read.

When the one or more cookies have been read, method 300 moves to step 312 to extract the membership tag from the one or more cookies. In the present invention, the on-line company extracts a membership tag from both the session-based cookie and the persistent cookie. Alternately, a membership tag can be extracted from only the session-based cookie or the persistent cookie. The membership tag can be extracted by, for example, reading selected portions of the cookies.

Following this, method 300 moves to step 314 to evaluate the extracted membership tag to determine if the on-line user is a member of the organization. The extracted membership tag can be directly evaluated, or manipulated by an algorithm before being evaluated. When the on-line user is not a member of the organization, or the on-line company was unable to read a cookie from the on-line user, method 300 moves to step 316 to indicate that the on-line user is not a member and the service is not authorized.

On the other hand, when the on-line user is a member of the organization, method 300 moves to step 318 to indicate that the on-line user is a member and the service is authorized. Thus, in the present invention, the service is provided by the company to the on-line user only when the on-line user is a member of the organization.

In accordance with the present invention, the organization and the company are unrelated entities. In addition, the organization can be sponsored by or owned by a business where the business and the on-line company are unrelated entities. In the present invention, related entities are defined to be entities that share a common ownership or control link.

For example, a common ownership or control link exists between a first entity and a second entity when the first entity owns the second entity, controls the second entity, or has a majority of the shares in the second entity. A common ownership or control link also exists between a first entity and a second entity when a third entity owns the first and second entities, controls the first and second entities, or has a majority of the shares in the first and second entities.

Thus, in the present invention, unrelated entities are defined to be entities that do not share a common ownership or control link. The unrelated entities can have contracts, licenses, and other arm's length business relationships as long as there is no common ownership or control link.

One of the advantages of the present invention is that the present invention allows an on-line company to provide a service to a member of an organization by sharing nothing more than a membership tag or identifier that can be extracted from a cookie. As noted above, the tag includes no personally identifying information.

Thus, the present invention allows an organization the ability to provide their members a service offered by an unrelated company that does not require the disclosure of personally identifying membership information. Further, the on-line user's status as a member can be provided only with the members consent when the request for the service is initiated by the on-line user, such as requesting a discount or a particular file.

In addition, the present invention eliminates the time and cost required from the organization to continually provide current membership information. Further, the present invention eliminates the cost to the on-line company of processing and maintaining the membership information.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A method of providing an on-line service, the method comprising the steps of:
collecting information from an on-line user that indicates a service the on-line user has selected to receive from a company, the on-line user using a computer, the company having a server, the server having an IP address;
determining if the on-line user is a member of an organization after the on-line user has selected the service, the organization having a web site, a domain name, an IP address associated with the domain name, a sub-domain of the domain name, and an IP address associated with the sub-domain, the IP address associated with the sub-domain being the IP address of the server such that all packets addressed to the sub-domain are forwarded to the server; and
providing the service to the on-line user when the on-line user is a member of the organization.

2. The method of claim 1 wherein the company and the organization are unrelated entities.

3. The method of claim 2 wherein the determining step is performed by the company.

4. The method of claim 3 wherein the determining step includes the steps of:
reading a cookie placed by the organization on the computer used by the on-line user;
extracting a membership tag from the cookie; and
evaluating the membership tag to determine whether the on-line user is a member of the organization.

5. The method of claim 4 wherein the membership tag includes no personally identifying information.

6. The method of claim 5 wherein the organization stores the cookie on the computer used by the on-line user when the on-line user logs onto the web site of the organization.

7. The method of claim 6 wherein the service is provided by the company to the on-line user only when the on-line user is a member of the organization.

8. The method of claim 5 wherein the service is a discount to a product to be purchased by the on-line user.

9. The method of claim 5 wherein the service is a digital file to be downloaded by the on-line user.

10. The method of claim 5 wherein the organization is sponsored by a business such that the business and the on-line company are unrelated entities.

11. The method of claim 1 wherein the determining step includes the steps of:
reading a cookie placed by the organization on the computer used by the on-line user;
extracting a membership tag from the cookie, the membership tag including no personally identifying information; and
evaluating the membership tag to determine whether the on-line user is a member of the organization.

12. A method of providing an on-line service, the method comprising the steps of:
identifying an IP address of a server of an on-line company, the on-line company providing a service;
establishing a sub-domain name of a domain name of a web site of an organization, the sub-domain name having an associated IP address, the organization having a plurality of members; and
setting the associated IP address to be equal to the IP address of the server.

13. The method of claim 12 wherein the on-line company and the organization are unrelated entities.

14. The method of claim 13 and further comprising the step of storing a cookie on a computer used by an on-line user when the on-line user logs onto the web site of the organization after the associated IP address has been set to be equal to the IP address of the server, the cookie having a membership tag that includes no personally identifying information.

15. The method of claim 13 wherein all packets addressed to the sub-domain are forwarded to the server.

16. The method of claim 13 wherein the service is a discount to a product to be purchased by the on-line user.

17. The method of claim 13 wherein the service is a digital file to be downloaded by the on-line user.

18. The method of claim 13 wherein the organization is sponsored by a business such that the business and the on-line company are unrelated entities.
